(19) United States
(12) Patent Application Publication
(10) Pub. No.: US 2015/0239752 A1
(43) Pub. Date: Aug. 27, 2015

(54) Reverse Osmosis System with Drain Water Recycle

(71) Applicant: Gregory Nicholas Cooper, (US)

(72) Inventor: John M. Tulloch, Memana (AU)

(21) Appl. No.: 14/190,134

(22) Filed: Feb. 26, 2014

(51) Int. Cl. C02F 1/44; C02F 1/00

(52) U.S. Cl. CPC C02F 1/441; C02F 1/008

(57) ABSTRACT

A water purification system for producing potable water includes a pump to force water from a source tank through one or more filters and a high-pressure pump for pumping filtered water into a reverse osmosis membrane, thereby producing potable water. Drain water from the reverse osmosis membrane is pressurized by a recirculation pump and fed back into the reverse osmosis membrane, thereby reducing power consumption and waste of water. The high-pressure pump and recirculation pump is driven by a common motor to provide additional power efficiency and to synchronize both pumps. In some embodiments, the disclosed system produces potable water using power from a solar panel.

### FIELD

This invention relates to the field of water purification and more particularly to a system for water purification where electric power is sparse.

### BACKGROUND

There are many situations and places where a stable source of drinking water is needed in which very little electrical power is available. Such situations and places include remote locations, small islands, and isolated locations; but also include places that normally have well established power grids that are somehow disabled, perhaps by some sort of disaster. The list of places where potable water is needed, especially where electric or other power is limited includes small islands, third-world countries, areas affected by disaster (hurricanes, earthquakes, tsunami, war, etc.), boats, isolated locations, locations with sparse population, etc.

There are several ways to make water potable. One such way is through a chemical process, in such, adding a chemical that neutralizes microbes within the water to make the water suitable for drinking. This works on small scales such as when an individual is camping or lost in the wilderness, but is generally not suited for providing drinking water to a larger population.

Of course, the standard reservoir and filtration system is well known, but relies on a relatively clean source of water from a lake or stream that is pressurized, filtered, and chemically treated. This type of system requires significant power (electricity) and is not very portable, so not suited for remote locations or for use during emergencies.

Another know way of providing potable water from a non-potable source is to boil the water for a long enough period of time as to kill any microbes in the water. This too requires significant power (electricity, propane, etc.), is not very portable, and requires a supply of energy such as propane at the location where purification is performed. During the boiling process, a large portion of the non-potable water evaporates and is lost into the air. This loss of water is inefficient, is an issue, especially in areas that have little water. Furthermore, boiling (unless distilling) does not remove hazardous chemicals from the water.

Another know way of providing potable water from non-potable water is a system called reverse osmosis, in which the non-potable water is pressurized, filtered, then presented to a membrane through which very little passes, except for pure water molecules, thereby providing potable water at the other side of the membrane. This too requires significant power (electricity) to pump the water through the membrane and also, because of the structure of the membrane, results in a large portion of the non-potable water passing by the membrane and out a drain. Therefore, like the boiling process, a portion of the non-potable water is lost which is an issue in areas that have little water.

What is needed is a system that will render water potable using minimal amounts of electricity, such as electricity from a solar panel.

### SUMMARY

A water purification system for producing potable water includes a pump to force water from a source tank through one or more filters and a high-pressure pump for pumping filtered water into a reverse osmosis membrane, thereby producing potable water. Drain water from the reverse osmosis membrane is pressurized by a recirculation pump and fed back into the reverse osmosis membrane, thereby reducing power consumption and waste of water. The high-pressure pump and recirculation pump is driven by a common motor to provide additional power efficiency and to synchronize both pumps. In some embodiments, the disclosed system produces potable water using power from a solar panel.

In one embodiment, a water purification system is disclosed including a low pressure pump coupled to a source of water. The low pressure pump pressurizing water from the source of water. An input of at least one filter media is in communication with the low pressure pump, such that the water is forced through the at least one filter media by the lower pressure pump. An input of a high pressure pump is in communication with an output of the at least one filter media provides pressurized water to an input of a reverse osmosis membrane. A recirculate pump that is in communication with a drain of the reverse osmosis membrane recirculates water from the drain of the reverse osmosis membrane to the input of the reverse osmosis membrane. Clean water (e.g. potable water) is delivered from the output of the reverse osmosis membrane.

In another embodiment, a water purification system is disclosed including a low pressure pump coupled to a source of water with a first electric motor operatively coupled (driving) to the low pressure pump. An input of at least one filter media is in communication with the low pressure pump, such that the water is forced through the at least one filter media by the lower pressure pump. A first pressure sensor is in communication with the output of the at least one filter media. An input of high pressure pump is in communication with an output of the at least one filter media and a second pressure sensor is in communication with the output of the high pressure pump. An output of the high pressure pump is in communications with an input of a reverse osmosis membrane. A drain of the reverse osmosis membrane is in communication with a recirculate pump and a second electric motor is operatively coupled to both the high pressure pump and the recirculate pump. A controller is in electrical communications with the first electric motor, the second electric motor, the first pressure sensor, and the second pressure sensor, such that the controller adjusts the speed of the first electric motor and the second electric motor and the controller has access to a first electrical signal indicating a first pressure from the first pressure sensor and a second electrical signal indicating a second pressure from the second pressure sensor, such that clean (potable) water is delivered from the output of the reverse osmosis membrane.

In another embodiment, a method of purifying water is disclosed including forcing unpurified water through at least one filter by a low pressure pump, creating filtered water, then pumping the filtered water to a high pressure by a high pressure pump into an input of a reverse osmosis membrane. Creating a purified water output from the filtered water using the reverse osmosis membrane, the purified water delivered from an output of the reverse osmosis membrane and recapturing and recirculating drain water from the reverse osmosis membrane back into the input of the reverse osmosis membrane by a recirculation pump. Both the high pressure pump and the recirculation pump being driven by a single motor.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of an exemplary reverse osmosis system with drain water recycling.

FIG. 2 illustrates a schematic view of an exemplary controller used in the reverse osmosis system with drain water recycling.

FIG. 3 illustrates a block diagram of an exemplary reverse osmosis system with drain water recycling powered by solar energy.

FIG. 4 illustrates a flow chart of an exemplary software control for the reverse osmosis system with drain water recycling powered by solar energy.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Note that throughout this specification the term water refers to the colloquial meaning of water and is not limited to the chemical formulation of H₂0. When a reference is made to water, the reference is to a liquid composition of H₂0 (pure water) along with any other dissolved or suspended materials, organic or inorganic, such as rain water, lake water, water from streams, well water, ocean water, tap water, etc.

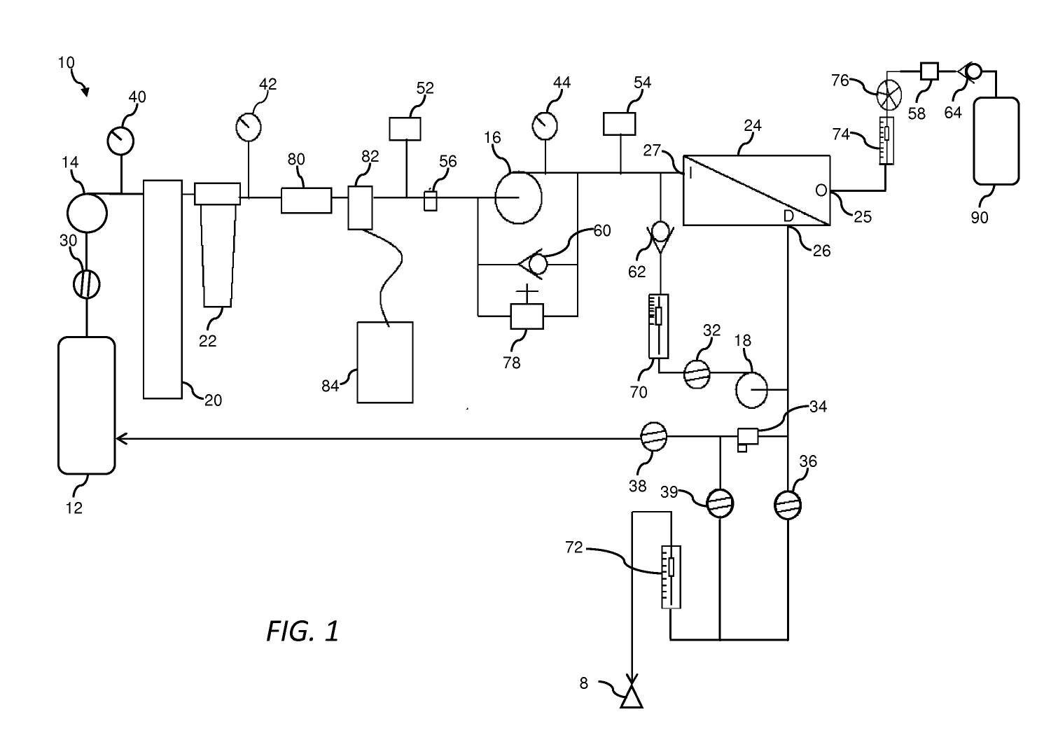

Referring to FIG. 1, a schematic view of an exemplary reverse osmosis system with drain water recycling 10 is shown. The reverse osmosis system with drain water recycling 10 accepts input water from, for example, a holding tank 12, or any other source such as a pond, lake, stream, ocean, water tower, etc. The reverse osmosis system with drain water recycling 10 purifies the water by removing a majority of the dissolved or suspended materials, creating potable water that is, for example, stored in a second, clean-water tank. The reverse osmosis system with drain water recycling 10 pressurizes the input water and forces the input water through a semipermeable membrane, applying sufficient water pressure as to overcome osmotic pressure of the semipermeable membrane. The use of reverse osmosis for purification of drinking water is well known, as many use such systems to further purify drinking water from already pressurized tap water. Such systems produce limited amounts of purified water, typically a few gallons per day for home use, and do not require additional power (electricity) because the input water is already pressurized by, for example, municipal water works. Such reverse osmosis systems will not produce sufficient water in the examples described in the background above, especially being that the input water is not sufficiently pressurized (a small amount of pressure is anticipated from the mass of the input water due to gravitational pull).

The reverse osmosis system with drain water recycling 10 must pressurize the input water 12 with enough pressure to push the input water through one or more input filters such as the first stage filter 20 and second stage filter 22 to create intermediate water that is cleaner than the input water having less dissolved or suspended particles (e.g. sift, rust, calcium carbonate). In the example shown, the first stage filter 20 typically removes trapped particles such as rust and calcium carbonate) while the second stage filter 22, containing activated carbon, removes some organic chemicals and chlorine. This produces an intermediate water that is cleaner than the input water but the intermediate water possibly contains smaller particles such as microbes, chemical compounds, etc. The intermediate water then must be pressurized with enough pressure to overcome the osmotic pressure of the reverse osmosis membrane 24.

Before proceeding with the description, typical reverse osmosis systems used, for example, in a home are very inefficient, recovering only around 5-15% of the input water, the remainder being discharged to a drain. Therefore, to produce one gallon of drinking water, on average, such systems require 10-15 gallons of input water, sending 9-14 gallons of drinking water down the drain. In localities having sufficient sources of water (e.g. reservoirs, rivers, lakes) this is not so much an issue. In contrast, in the localities describe above, water is precious and it is not practical to discard such a great percentage of the water to a drain.

To reduce waste of the intermediate water and to reduce power consumption, the drain water from the reverse osmosis membrane 24 is recycled and remixed with the intermediate water.

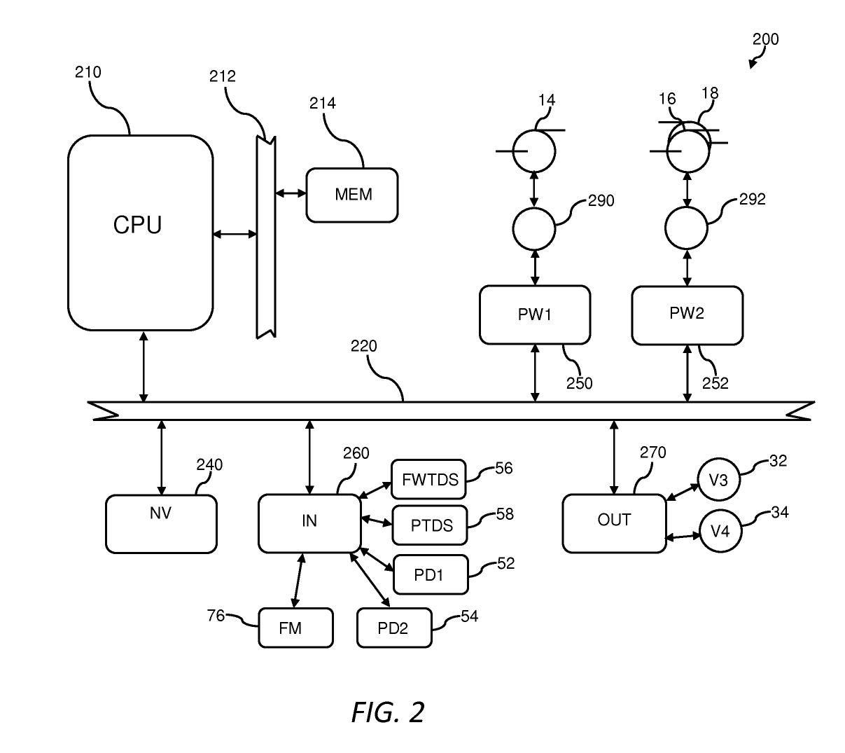

The reverse osmosis system with drain water recycling 10 has a supply pump 14 that pumps water from the supply tank 12 and pressurizes the input water with sufficient pressure as to pass the water, minus some impurities, through the first stage filter 20 and the second stage filter 22, thereby creating filtered water. In this example, the supply pump 14 is driven by a supply motor 290 that is controlled by the controller 200 (see FIG. 2) to obtain the proper intermediate water pressure. A low pressure sensor 52 converts the intermediate water pressure into an electrical signal that is connected to the controller 200 so that the controller 200 is able to monitor the intermediate water pressure.

In some embodiments, the filtered water passes through a feed water total dissolved solids sensor 56 which measures an amount of total dissolved solids and converts that amount into an electrical signal that is connected to the controller 200 so that the controller 200 is able to monitor the amount of total dissolved solids in the filtered water. In this way, the controller 200 has knowledge of the integrity and robustness of the input filters 20/22.

For completeness (not required for operation), an inlet valve 30 and an inlet pressure gauge 40 are show in FIG. 1. Another pressure gauge 42 (optional) shows the pressure of the filtered water after the filters 20/22. Note that although two filters 20/22 are shown, any quantity and type of filter(s) is/are anticipated. In some embodiments, particularly for fresh input water, the filtered water flows through an optional scale prevention device 80.

In some embodiments, particularly in which the input water contains salinity (e.g. sea water), a chemical feed pump 82 pumps small amounts of a chemical from a chemical solution tank 84. Although the chemicals used in the desalinization industry are typically proprietary formulations, it is assumed that these chemicals are a blend of a surfactant and a mild organic acid. The chemical feed pump 82 typically adds around 3 mg of the chemical solution per liter of filtered water. The chemical solution winds up in the drain water and no traceable amounts of the chemical solution wind up in the treated (purified) water. The same chemical solutions are often used for fresh or brackish water.

The filtered water is then pressurized to sufficient pressure as required for the reverse osmosis membrane 24 by a high pressure pump 16 driven by a second motor 292 (see FIG. 2), the output pressure of which is shown on an optional pressure gauge 44. Should the pressure of the filtered water created by the supply pump 14 provide more pressure than the high pressure pump 16 (e.g. the high pressure pump 16 is not operating), the filtered water at such pressure is allowed to bypass the high pressure pump 16 through a check valve 60. Should the pressure of the filtered water exceed a safe level, a pressure relief valve 78 is provided. The common second motor 292 drives both the high pressure pump 16 and the recirculate pump 18. By utilizing a common second motor 292, at least two advantages are achieved. The first advantage is a common second motor 292 consumes less electrical energy compared with two motors driving two similar capacity pumps. The second advantage is that the flow rates of both pumps are maintained synchronized at the same ratios to one another. Therefore, as the common second motor 292 speed changes, the flow rates through both the high pressure pump 16 and the recirculate pump 18 changes to follow the motor's speed, maintaining the same relative pump rates. For example, if the high pressure pump 16 delivers 10 gph at one motor speed and 20 gph (double) at a second motor speed, the recirculate pump 18 will provide double the flow rate at the second motor speed. Note that in mounting two pumps 16/18 to the common second motor 292 with two extending shafts, the rotational direction of the first pump 16 will be opposite to the rotational direction of the second pump 18 and, therefore, to operate correctly, a reverse rotation pump is preferred for one of the pumps 16/18. In an alternate embodiment, a pair of gears provides proper rotation, but the addition of gears creates another mechanism that must be maintained and has a failure rate and such addition of gears reduces efficiency. Another alternative is to use a single ended shaft that is long enough to be coupled to two, side-by-side pumps.

The common second motor 292 is controlled by the controller 200 (see FIG. 2) to obtain the water pressure required by the reverse osmosis membrane 24. A high pressure sensor 54 converts the filtered water pressure after the high pressure pump 16 into an electrical signal that is connected to the controller 200 so that the controller 200 is able to monitor the water pressure provided to the input 27 of the reverse osmosis membrane 24.

Instead of discarding the drain water from the drain 26 of the reverse osmosis membrane 24, the drain water is recirculated. Because some of the high pressure filtered water leaves the output of the reverse osmosis membrane 24 as purified water (from the reverse osmosis membrane 24 output 25), the water pressure at the drain 26 of the reverse osmosis membrane 24 is lower than the high pressure filtered water at the input 27 of the reverse osmosis membrane 24. Therefore, a direct connection of the drain 26 of the reverse osmosis membrane 24 to the high pressure filtered water is not possible. Instead, the pressure of the drain water from the drain 26 of the reverse osmosis membrane 24 is increased by the recirculate pump 18 and recirculated back into the input 27 of the reverse osmosis membrane 24 through a recirculate check valve 62. A first flow meter 70 measures the flow of the drain water through the recirculate pump 18.

As discussed above, the common motor 292 drives both the high pressure pump 16 and the recirculate pump 18, thereby providing a controlled flow ratio between both pumps 16/18. A further power savings is realized by this recirculation because the drain water from the drain 26 of the reverse osmosis membrane 24 has already passed through the input filters 20/22 and does not need to pass through the input filters 20/22 again, as would be needed if the drain water from the drain 26 of the reverse osmosis membrane 24 is instead deposited back into the input tank 12. A still further power savings is achieved because, although the pressure of the water from the drain 26 of the reverse osmosis membrane 24 is not as high as the water pressure at the input 27 of the reverse osmosis membrane 24, there is some substantial pressure and, hence, the amount of power (to the common second motor 292) needed to increase the pressure of the water from the drain 26 of the reverse osmosis membrane 24 is less than the amount of power needed to increase the pressure of the input water.

In some embodiments, the fixed ratio between the pumps 16/18 is between 1:5 and 1:4, for example, for a certain motor speed, the high pressure pump 16 moves 150 gallons per hour (GPH) and the recirculate pump 18 moves 706 gallons per hour.

After a period of operation in which the drain water from the drain 26 of the reverse osmosis membrane 24 is recirculated several times, it is anticipated that the amount of dissolved solids will reach a point at which the drain water from the drain 26 of the reverse osmosis membrane 24 has too much dissolved solids, at which time the water from the drain 26 of the reverse osmosis membrane 24 is sent to either the input tank 12 or to an external drain 8 (e.g. sewerage system, irrigation system, pond, etc.) upon operation of an electrically operated valve 34 under control of the controller 200. Several valves 32/36/38/39 are set to control the flow of the water from the drain 26 of the reverse osmosis membrane 24 either back to the input tank 12 or to the external drain 8. In some embodiments, a second flow meter 72 measures the amount of water flowing out the drain. Any configuration of manual and/or electrically controlled valves 32/34/36/38/39 are anticipated, on such example is shown in the drawings.

The purified water from the output 25 of the reverse osmosis membrane 24 passes through an optional third flow meter 74, then an optional totalizing meter 76. The amount of total dissolved solids (tds) in the potable water is monitored by a permeate total dissolved solids sensor 58 before the potable water is, for example, stored in the clean water holding tank 90. If there is any possibility of back pressure, the third check valve 64 prevents a reverse flow of water from the clean water holding tank 90 to the reverse osmosis membrane 24.

Referring to FIG. 2, a schematic view of an exemplary controller 200 used in the reverse osmosis system with drain water recycling 10 is shown. The controller 200 is an exemplary controller as it is well known that many configurations of processors, memory, input/output are feasible producing similar results, as well as it is well known that it is possible to implement most any system having a processor by a discrete system.

The exemplary controller 200 represents one such typical computer, micro-controller, or programmable controller system used for controlling motors, valves, and the like; many other systems and architectures are equally anticipated. The example controller 200 is shown in its simplest form, having a single processor. Many different controller 200 architectures are known that accomplish similar results in a similar fashion and the present invention is not limited in any way to any particular controller 200. The present invention works well utilizing a single processor system as shown in FIG. 2, though there is no limitation on the number of processors, or the type of processor, if any. In this example of the controller 200, a processor 210 executes or runs stored programs that are generally stored for execution within a memory 214. The processor 210 is any processor or a group of processors, for example an Intel® 80C42 or the like. The memory 214 is typically connected to the processor by a memory bus 212 and is any memory 214 suitable for connection with the selected processor 210, such as SRAM, DRAM, SDRAM, RDRAM, DDR, DDR-2, etc. Also connected to the processor 210 is a system bus 220 for connecting to peripheral subsystems such as non-volatile storage 240, input ports 260, and output ports 270.

In general, the non-volatile storage device 240 (e.g. hard disk, flash memory, etc.) is used to store programs, executable code and data persistently, examples of such includes core memory, FRAM, flash memory, etc. In some embodiments, other devices are connected to the system through the system bus 230 or with other input-output connections/arrangements as known in the industry. Examples of these other devices include displays, indicator lights, sound-generation devices, etc.

The input ports 260 are connected to various sensors and gages such as the feed water total dissolved solid sensor 56, the permeate total dissolved solids sensor 58, the low pressure sensor 52, the high pressure sensor 54, and the totalizing meter 76.

The output ports 270 are connected to remote control valves 32/34 that open/close under flow or absence of electrical power.

To control the motors 290/292, the amount of power to each motor is controlled by one or more motor control circuits 250/252. In a preferred embodiment, a first motor control circuit 250 controls power to the first motor 290 that turns the supply pump 14 and a second motor control 252 controls power to the common second motor 292 that turns the high pressure pump 16 and the recirculate pump 18. In such preferred embodiment, the motor control circuits 250/252 are pulse-width modulating circuits that adjust widths of power pulses of constant amplitude. In such, the pulse-width modulating circuits decrease the pulse-width to slow the associated motor 290/292 (zero pulse-width is “stop”) and increase the pulse-width to increase the speed of the motor 290/292 (100% pulse width is full power). Such pulse-width modulation works well with DC motors, though any form of voltage, pulse-width, and/or current control is equally anticipated.

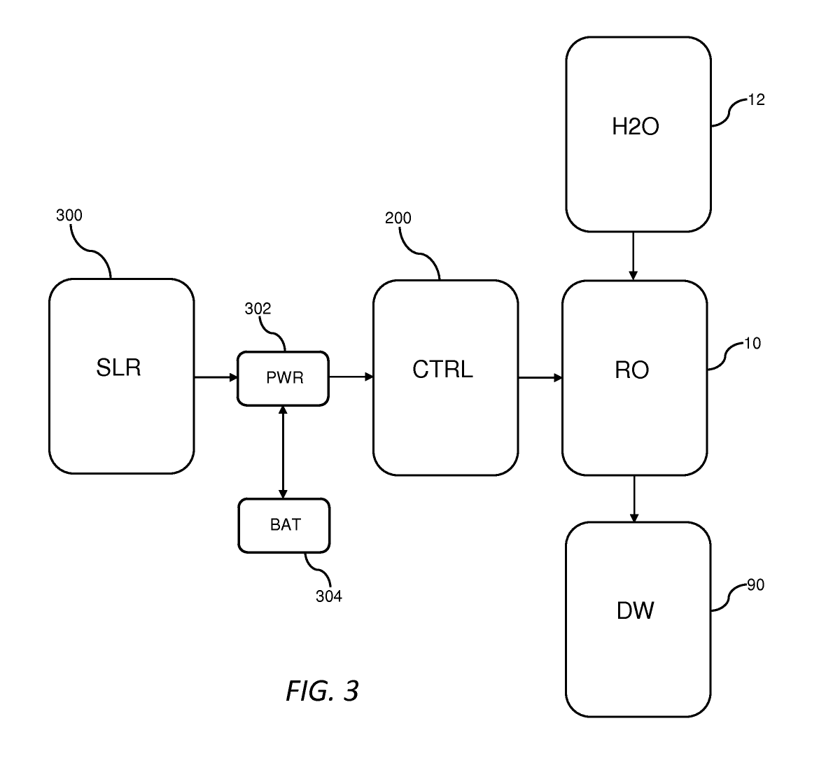

Referring to FIG. 3, a block diagram of an exemplary reverse osmosis system 10 with drain water recycling powered by solar energy is shown. In this system, the controller 200 and, therefore, the electrical components (e.g. motors 290/292) of the reverse osmosis system with drain water recycling 10 are powered by a solar panel 300. Power from the solar panel 300 is conditioned by a power conditioning circuit 302, which provides a clean, regulated DC voltage to the controller 200 and motors 290/292. In some embodiments (not required), an energy storage device 304 is included. The power conditioning circuit 302 regulates the raw power from the solar panel 300 and in embodiments in which the energy storage device 304 is included, the power conditioning circuit 302 monitors available power, charging the energy storage device 304 when excess electrical power is available (e.g. bright sunlight) and utilizing stored electricity from the energy storage device 304 when insufficient power is available from the solar panel 300 (e.g. during cloudy situations or at night). When present, any energy storage device 304 is anticipated, including, but not limited to rechargeable batteries and super capacitors.

Since DC motors have minimum and maximum operating voltages, the controller 200 monitors the power coming from the power conditioning circuit 302 (and optionally the energy storage device 304) and, if there is insufficient power to operate one or both of the motors 290/292, the controller 200 shuts off power to the motors 290/292 to prevent failure from overheating, etc.

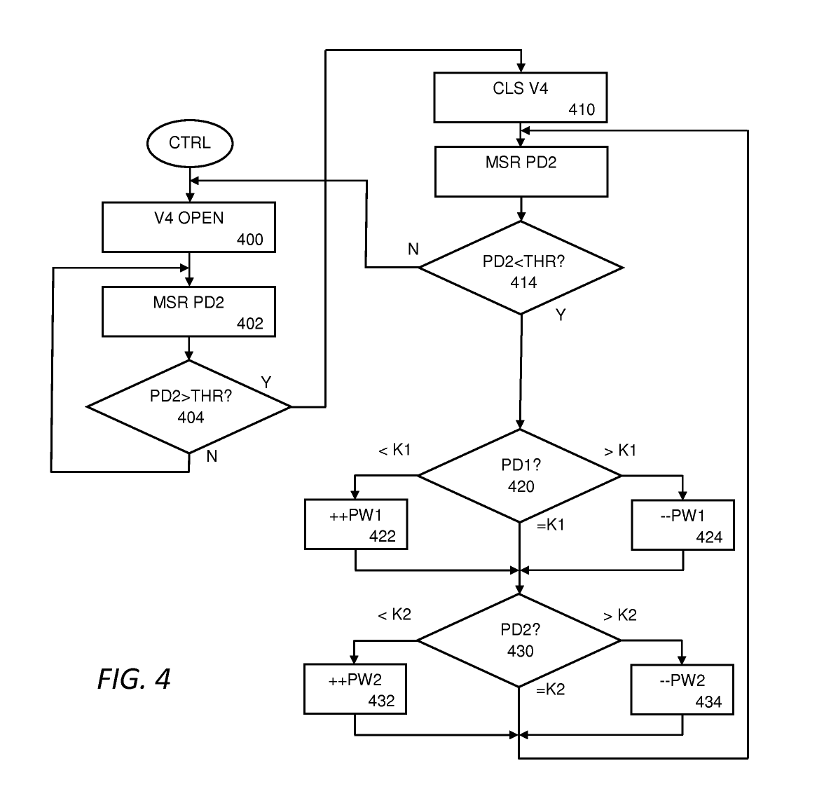

Referring to FIG. 4, a flow chart of an exemplary software control for the reverse osmosis system with drain water recycling 10 powered by, for example, solar energy is shown. Many software systems are anticipated to control the reverse osmosis system with drain water recycling 10, the following being one example. There are multiple goals of such a system, including, reducing power consumption to a minimum, protecting the reverse osmosis membrane 24 from damage during times of low power (e.g. when the sun is blocked from the solar panel(s) 300, delivering as much clean water as needed, minimizing wasted water, etc.

That being said, in the exemplary flow starting in FIG. 4 includes a start-up scenario in which water is recycled back to the water source 12 until sufficient input power is available (e.g. sufficient sunlight shining on the solar panel 300). The flush valve 34 is electrically opened 400 and a loop runs until the power is sufficient to provide sufficient pressure at the input 27 of the reverse osmosis membrane 24. The high pressure sensor 54 is read 402 providing the pressure at the input 27 of the reverse osmosis membrane 34. This pressure is compared 404 to a minimum pressure threshold. If the pressure at the input 27 of the reverse osmosis membrane 24 is less than needed 404, the loop 402/404 continues. For example, if the pressure at the input 27 of the reverse osmosis membrane 24 is less than 100 psi, the loop 402/404 continues.

Once the pressure at the input 27 of the reverse osmosis membrane 24 is sufficient 404 (e.g. greater than 100 psi), the recycle valve 34 is closed 410. The drain water from the drain 26 of the reverse osmosis membrane 24 is repeatedly recirculated, except for a small drain bleed that exits through the drain control valve 36 to the external drain 8.

A second loop starts in which, again, the pressure at the input 27 of the reverse osmosis membrane 24 is measured 412 and compared to a threshold 414 (the same or different threshold as the previous comparison 404). If the pressure at the input 27 of the reverse osmosis membrane 24 is found to be low 414 (e.g. drops below a required minimum pressure for the selected reverse osmosis membrane 24, for example 100 psi), the recycle valve is again opened 400 and the prior loop 402/404 restarts.

If 414 there is sufficient pressure at the input 27 of the reverse osmosis membrane 24, the low pressure sensor 52 is read to determine the pressure after the filters 20/22. It is desired to maintain a given pressure, K1, at the output of the filters 20/22, which is, for example, 50 psi. As one would expect, when the filters 20/22 are new, the supply pump 14 does not need to pump as much as when the filters 20/22 are near the end of their life. For example, when the filters 20/22 are new, the supply pump 14 need only provide around 60 psi to achieve 50 psi at the output of the filters 20/22, but as the filters 20/22 buildup contaminants, more than 60 psi must be provided. Therefore, if the pressure measured by the low pressure sensor 52 is less than K1 (e.g. lower than 50 psi) 420, power is increased 422 to the motor 290 driving the supply pump 14 by, for example, increasing the pulse width from the first motor control circuit 250. Likewise, if the pressure measured by the low pressure sensor 52 is higher than K1 (e.g. higher than 50 psi) 420, power is decreased 424 to the motor 290 driving the supply pump 14 by, for example, decreasing the pulse width from the first motor control circuit 250.

It is desired to maintain a given pressure, K2, at the input of the reverse osmosis membrane 24, which is, dependent upon the source water chemistry, total dissolved solids, and the specifications of the reverse osmosis membrane 24. For example, if the water from the source has up to around 600 PPM (parts per million) of total dissolved solids, then the reverse osmosis membrane 24 is selected for 150 psi and the pressure target, K2, is 150 psi. In another example, if the water from the source is salt water, then the reverse osmosis membrane 24 is selected for around 1000 psi and the pressure target, K2, is 1000 psi. The pressure at the input of the reverse osmosis membrane 24 is measured by the high pressure sensor 54. The pressure at the input of the reverse osmosis membrane 24 is contributed to by the output of the high pressure pump 16 and the recirculate pump 18, both driven by the common second motor 292. If the pressure measured by the high pressure sensor 54 is less than K2 (e.g. lower than 150 psi) 430, power is increased 432 to the common second motor 292 connected to the high pressure pump 16 and the recirculate pump 18 by, for example, increasing the pulse width from the second motor control circuit 252. Likewise, if the pressure measured by the high pressure sensor 54 is higher than K2 (e.g. higher than 150 psi) 430, power is decreased 434 to the common second motor 292 connected to the high pressure pump 16 and the recirculate pump 18 by, for example, decreasing the pulse width from the second motor control circuit 252.

By recirculating drain water from the drain 26 of the reverse osmosis membrane 24 through the recirculate pump 18, power and water are saved. Power is saved because this water has already been filtered by the filters 20/22 so there is no extra energy needed to push this water through the filters 20/22, and additional power is saved because the water coming out of the reverse osmosis membrane's 24 drain 26 is already pressurized to around 5-20 psi less than the pressure at the input 27 to the reverse osmosis membrane 24. Therefore, since the water from the drain 26 of the reverse osmosis membrane's 24 is already pressurized, less power is needed to bring the pressure to a level required to meet the pressure delivered by the high pressure pump 16.

Overall power consumption as well as pump synchronization, is also achieved by operating both the high pressure pump 16 and the recirculate pump 18 by the same motor 292.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A water purification system comprising:
a low pressure pump operatively coupled to a source of water for pressurizing water from the source of water;
at least one filter media, an input of the at least one filter media in communication with the low pressure pump, the water forced through the at least one filter media by the low pressure pump;
a high pressure pump, an input of the high pressure pump in communication with an output of the at least one filter media;
a reverse osmosis membrane having an input, and output, and a drain, the input in communication with an output of the high pressure pump;
a recirculate pump, input of the recirculate pump in communication with the drain and an output of the recirculate pump in communication with the input of the reverse osmosis membrane;
a motor operatively coupled to both the high pressure pump and the recirculate pump; and
a pressure sensor, the pressure sensor in fluid communication with the output of the high pressure pump, whereas a speed of the motor is controlled inversely proportionate to an electrical signal from the pressure sensor, the electrical signal increasing in value as the pressure at the output of the high pressure increases;
whereas clean water is delivered from the output of the reverse osmosis membrane.

2. The water purification system of claim 1, wherein a first motor drives the low pressure pump.

3. The water purification system of claim 2, further comprising a first pressure sensor, the first pressure sensor in fluid communication with the output of the at least one filter media.

4. The water purification system of claim 3, further comprising a controller, the controller interfaced to the first motor, whereas the controller monitors the first pressure sensor and if the pressure from the first pressure sensor is less than a predetermined pressure, the controller increases the speed of the first motor and if the pressure from the first pressure sensor is greater than the predetermined pressure, the controller decreases the speed of the first motor.

5. (canceled)

6. The water purification system of claim 1, further comprising a controller, the controller interfaced to the motor, whereas the controller monitors the pressure sensor and if the pressure from the pressure sensor is less than a predetermined pressure, the controller increases the speed of the motor and if the pressure from the second pressure sensor is greater than the predetermined pressure, the controller decreases the speed of the motor.

7. The water purification system of claim 1, further comprising an electrically operated flush valve, one side of the electrically operated flush valve in communication with the drain of the reverse osmosis membrane and another side of the electrically operated flush valve in communication with an external drain, the electrically operated flush valve opened proportionate to the amount of total dissolved solids detected from the drain of the reverse osmosis membrane.

8. The water purification system of claim 1, further comprising an electrically operated flush valve, one side of the electrically operated flush valve in communication with the drain of the reverse osmosis membrane and another side of the electrically operated flush valve in communication with the source of water, the electrically operated flush valve opened proportionate to the amount of total dissolved solids detected from the drain of the reverse osmosis membrane.

9. A water purification system comprising:
a low pressure pump operatively coupled to a source of water for pressurizing water from the source of water;
a first electric motor, the first electric motor operatively coupled to the low pressure pump;
at least one filter media, an input of the at least one filter media in communication with the low pressure pump, the water forced through the at least one filter media by the lower pressure pump;
a first pressure sensor, the first pressure sensor in fluid communication with the output of the at least one filter media;
a high pressure pump, an input of the high pressure pump in communication with an output of the at least one filter media;
a second pressure sensor, the second pressure sensor in fluid communication with the output of the high pressure pump;
a reverse osmosis membrane having an input, and output, and a drain, the input of the reverse osmosis membrane in communication with an output of the high pressure pump;
a recirculate pump, input of the recirculate pump in communication with the drain and an output of the recirculate pump in communication with the input;
a second electric motor, the second electric motor operatively coupled to both the high pressure pump and the recirculate pump;
a controller, the controller in electrical communications with the first electric motor, the second electric motor, the first pressure sensor, and the second pressure sensor, such that the controller is capable of controlling the speed of the first electric motor and the second electric motor and the controller has access to a first electrical signal indicating a first pressure from the first pressure sensor and a second electrical signal indicating a second pressure from the second pressure sensor; and
an electrically operated flush valve, an input side of the electrically operated flush valve fluidly coupled to the drain of the reverse osmosis membrane and an output side of the electrically operated flush valve fluidly coupled to an external drain, the electrically operated flush opened proportionate to the amount of total dissolved solids detected at the drain of the reverse osmosis membrane;
whereas clean water is delivered from the output of the reverse osmosis membrane.

10. The water purification system of claim 9, whereas the controller monitors the first pressure transducer and if the first pressure from the first pressure sensor is less than a predetermined pressure, the controller increases the speed of the first motor and if the first pressure from the first pressure sensor is greater than the predetermined pressure, the controller decreases the speed of the first motor.

11. The water purification system of claim 9, whereas the controller monitors the second pressure transducer and if the second pressure from the second pressure sensor is less than a predetermined pressure, the controller increases the speed of the second motor and if the second pressure from the second pressure sensor is greater than the predetermined pressure, the controller decreases the speed of the second motor.

12. (canceled)

13. (canceled)

14. A method of purifying water, the method comprising:
forcing unpurified water through at least one filter by a low pressure pump, creating filtered water;
pumping the filtered water to a high pressure by a high pressure pump into an input of a reverse osmosis membrane;
creating a purified water output from the filtered water using the reverse osmosis membrane, the purified water delivered from an output of the reverse osmosis membrane;
recapturing and recirculating drain water from the reverse osmosis membrane back into the input of the reverse osmosis membrane by a recirculation pump;
turning both the high pressure pump and the recirculation pump by a single motor;
measuring a pressure at the input of the reverse osmosis membrane;
controlling a speed of the single motor inversely proportionate to the pressure at the input of the reverse osmosis membrane.

15. The method of claim 14, further comprising:
measuring a pressure of the filtered water at an output of the at least one filter;
increasing the speed of a motor driving the low pressure pump responsive to the pressure being below a preset desired low pressure; and
decreasing the speed of a motor driving the low pressure pump responsive to the pressure being above the preset desired low pressure.

16. The method of claim 14, further comprising:
increasing the speed of the single motor driving the high pressure pump and the recirculation pump responsive to the pressure at the input of the reverse osmosis membrane being below a preset desired high-pressure; and
decreasing the speed of the single motor driving the high pressure pump and the recirculation pump responsive to the pressure at the input of the reverse osmosis membrane being above the preset desired high-pressure.

17. The method of claim 14, further comprising:
periodically opening a flush valve, the flush valve sending the drain water back into a source of the unpurified water.

18. The method of claim 14, further comprising:
periodically opening a flush valve, the flush valve sending the drain water to an external drain.
